(19) United States
(12) Patent Application Publication
(10) Pub. No.: US 2009/0028453 A1
(43) Pub. Date: Jan. 29, 2009

(54) Content Encoder and Decoder and Methods of Encoding and Decoding Content

(75) Inventors: John Collomosse, Bath Avon (GB); Timothy Paul James Gerard Kindberg, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 12/179,779

(22) Filed: Jul. 25, 2008

(30) Foreign Application Priority Data
Jul. 27, 2007 (GB) 0714666.5

(51) Int. Cl. G06K 9/46

(52) U.S. Cl. 382/243

(57) ABSTRACT

A content encoder for encoding content in a source image for display on a display device, the content encoder comprising: inputs for receiving data representing content to be encoded in the source image; a processor arranged to encode content as a time varying two-dimensional pattern of luminosity modulations within the source image to form an encoded image; outputs arranged to output the encoded image to the display device.

### TECHNICAL FIELD

The present invention relates to a content encoder and a content decoder and methods of encoding and decoding content.

### BACKGROUND TO INVENTION

Printed codes such as Universal Product Codes (UPC), QR codes and Datamatrix codes enable items (such as goods for sale or mail within a mail system) to be marked and later identified by a suitable reader device. A QR Code is a matrix code (or two-dimensional bar code). The “QR” is derived from “Quick Response”, a reference to the speed and ease in which the code may be read. A DataMatrix code is a two-dimensional matrix barcode consisting of black and white square modules arranged in either a square or rectangular pattern. The reader device generally comprises a camera and specialist software.

The provision of camera devices within mobile telecommunications devices has enabled camera enabled mobile devices to serve as code readers. It is noted however that the low resolution and poor optics of cameras within mobile devices tends to place an upper limit on the data density of the codes. Furthermore, not only do codes often occupy large areas but there is minimal scope for customising the appearance of the codes.

It is also possible to distribute data amongst several independent codes and displaying each in turn. However, such methods still require large areas to be dedicated to the code.

### DESCRIPTION OF EMBODIMENTS OF THE INVENTION

According to a first embodiment of the present invention there is provided a content encoder for encoding content in a source image for display on a display device, the content encoder comprising: inputs for receiving data representing content to be encoded in the source image; a processor arranged to encode content as a time varying two-dimensional pattern of luminosity modulations within the source image to form an encoded image; outputs arranged to output the encoded image to the display device.

The first embodiment of the present invention provides a content encoder that is arranged to encode data or content into an arbitrary image (source image) as a changing pattern of brightness fluctuations. As such the encoder of the present invention effectively trades space occupied by a code for decoding time (since a decoding device will need to receive all the time changing pattern of brightness fluctuations in order to decode the content encoded into the arbitrary image).

The encoding mechanism used by the content encoder of the present invention has a particular advantage over known printed code/camera device systems where the space for display of a code is at a premium. As an example, consider a situation where an image of a music album cover is displayed in a shop window alongside a two-dimensional barcode such as a QR code that can be scanned in order to initiate a purchase of the associated album music. Using the content encoder of the present invention the need for a secondary code region to accompany the album cover is eliminated which in turn reduces the display footprint for each album cover and enables more efficient use of the advertising space.

The encoding mechanism used by the encoder of the present invention is also advantageous where small displays (e.g. camera, printer or mobile device displays) are used as it enables larger data volumes to be transmitted from a small screen area than is possible using conventional QR, Datamatrix or UPC codes.

It is noted that prior art systems that encode data within an image encode either a fixed arrangement of data or, in the example of data encoded into a video display, encode data into the scan lines of the raster display. The present invention differs from these systems in that it encodes content as a changing pattern of brightness fluctuations.

Conveniently, the time-varying pattern may be encoded into the source image by generating a sequence of display frames for display by the display device. In such a case, a sequence of display frames may be created by taking a number of copies of the source image and encoding content into each one to form a sequence of encoded images for display.

Conveniently, in order to encode larger volumes of content or where the content to be encoded exceeds the data handling capacity of a single display frame, the two dimensional pattern of luminosity modulations varies from one display frame to the next in the sequence.

Conveniently, the two dimensional pattern may be formed from a grid of cells. Conveniently a rectangular or square grid of cells may be used. Other tessellating patterns of grid cells may however be used, e.g. hexagonal etc.

Each cell within the grid may comprise a plurality of display pixels. The ratio of pixels per grid cell may be varied in order to trade the capacity of the encoded image for decoding robustness.

Conveniently, where the two dimensional pattern is formed from a grid of cells, content may be encoded into the source image by raising or lowering the luminosity of pixels within a given cell in the grid.

Conveniently, each cell within the grid may be arranged to encode one bit of content related data. For example, a cell that is raised in brightness may encode a “1” and a cell which has its brightness reduced may encode a “0”. It is noted, however, that there may be more than one increased level of luminosity and more than one decreased level of luminosity that are applied to a cell in the grid. In this way, more than one bit of data may be encoded into any single cell.

Increasing or decreasing the luminosity of portions of the source image may result in unacceptable regions where the brightness of the image is either too high or too low. Therefore, conveniently, the processor may be arranged to scale the luminosity of the source image prior to encoding content.

It is envisaged that the encoded source image will be “read” by a suitable camera equipped device and it is noted that the orientation of the reader device may be different to that of the image display device used to display the encoded source image.

Conveniently, therefore, the processor is arranged to insert an orientation flag into the encoded image such that the reader device can ascertain the correct orientation of the displayed encoded image.

Conveniently, the orientation flag may comprise further modulation of the luminosity of the source image. For example, if the luminosity is modulated by a first amount to encode content then an orientation flag may be inserted by modulating the luminosity by a further amount. This further modulation may be applied to a predefined portion of the encoded image, e.g. to a specific quadrant of the encoded image.

Brightness discontinuities can be accentuated by the human visual system by virtue of the “Mach banding effect”. In order to reduce the likelihood of certain areas within the encoded image being given undue prominence, the processor may be arranged to attenuate the luminosity modulation applied to any given cell towards the edges of the cell.

Where the content is encoded by raising and lowering the luminosity of cells within the source image, a reader device may decode the received encoded image by observing cells in their “1” and “0” states in order to reconstruct an average image (i.e. the source image). Entropy may be added to the encoding system to increase the likelihood of any given cell experiencing both bit states. Conveniently, entropy may be added to the encoding mechanism by means of the processor inverting the two dimensional pattern for a subset of the display frames in the sequence of display frames. For example, every second frame may be inverted.

According to a second embodiment of the present invention there is provided a content decoder for decoding content encoded in a sequence of display frames, each display frame comprising an encoded image, the encoded image comprising a source image modulated by a two dimensional pattern of luminosity modulations to encode the content within the source image, the content decoder comprising: inputs for receiving the sequence of display frames; a processor arranged to (i) process the sequence of display frames to determine the two dimensional pattern of luminosity modulations; (ii) to sample the two dimensional pattern of luminosity modulations to determine the encoded content within each display frame, and (iii) to decode the encoded content to determine the content; outputs to output the content.

The second embodiment of the present invention provides a content decoder that is arranged to receive a sequence of encoded images and to decode them to determined the encoded content. Each display frame in the sequence of received display frames comprises a source image that has been modulated by a two dimensional pattern of luminosity modulations that encode content into the source image. The content decoder comprises a processor that is arranged to process the received sequence of display frames to determine the luminosity modulation pattern, to process this pattern to determine the encoded content and to decode the encoded content to determine the content.

It is noted that the two dimensional pattern of luminosity modulations may vary between received display frames and the processing step may therefore comprise processing all the received display frames to determine the two dimensional pattern of luminosity variations in each display frame and then to sample each of these patterns for encoded content and to decode the encoded content from each sampled frame.

In order to process the brightness fluctuations to determine the encoded content, the content decoder may analyse a number of received display frames in order to create an “average” image. In this way, the maximum and minimum values of each pixel within the display frame may be recorded over time and their mean value used to reconstruct the source image.

Alternatively, in order to process the brightness fluctuations to determine the encoded content, the content decoder may receive an un-modulated version of the source image.

In the event that the reader device that is used to receive the sequence of display frames is not aligned exactly with the display device, it is possible that the received frames may appear to be warped. It is also possible that only a portion of the display frames carries encoded content. Conveniently, therefore the processor is arranged to analyse the sequence of display frames to determine the location of the pattern of luminosity modulations within the each display frame. Further conveniently, the processor may be arranged to warp and/or crop the received display frames into a fixed shape.

Conveniently, the processor may be arranged to rotate the display frames to a predetermined orientation. This may be achieved with reference to an orientation flag that has been inserted into the display frames by an encoding device.

In the event that the pattern of luminosity variations are in the form of a grid of cells, the processor may conveniently be arranged to determine the resolution of the grid in the received sequence of display frames. For example, the processor may perform a Fourier analysis in order to determine grid resolution.

Once the grid resolution has been determined, the processor may then analyse each grid cell in order to determine encoded content within each grid cell.

In the event that the reader device used to capture the sequence of display frames has a refresh rate that differs from that of the display device it is noted that there is a possibility of capturing the same display frame twice. Therefore, conveniently, the processor is arranged to analyse the content within a current display frame and compare it to the content in the immediately previous display frame in the sequence and to discard the current display frame if it is substantially similar or identical to the immediately previous display frame.

According to a third embodiment of the present invention there is provided a method of encoding content in a source image for display on a display device, the method comprising the steps: receiving data representing content to be encoded in the source image; encoding the content into the source image to form an encoded image, content being encoded as a time varying two-dimensional pattern of luminosity modulations within the source image; outputting the encoded image to the display device.

It is noted that preferred features relating to the third embodiment of the present invention are described above in relation to the first embodiment of the invention.

According to a fourth embodiment of the present invention there is provided a method of decoding content encoded in a sequence of display frames, each display frame comprising an encoded image, the encoded image comprising a source image modulated by a two dimensional pattern of luminosity modulations to encode the content within the source image, the method comprising the steps of: receiving the sequence of display frames; processing the sequence of display frames to determine the two dimensional pattern of luminosity modulations; sampling the two dimensional pattern of luminosity modulations to determine the encoded content within each display frame; decoding the encoded content to determine the content; outputting the content.

It is noted that preferred features relating to the fourth as embodiment of the present invention are described above in relation to the second embodiment of the invention.

The invention extends to an image display system comprising an image display device and a content encoder according to the first embodiment of the invention and to an image capture system comprising a content decoder according to the second embodiment of the invention and an image capture device.

Therefore, according to a fifth embodiment of the present invention there is provided an image display system comprising an image display device and a content encoder for encoding content in a source image for display on a display device, the content encoder comprising: inputs for receiving data representing content to be encoded in the source image; a processor arranged to encode content as a time varying two-dimensional pattern of luminosity modulations within the source image to form an encoded image; outputs arranged to output the encoded image to the display device wherein the outputs of the content encoder are in communication with the content display device.

According to a sixth embodiment of the present invention there is provided an image capture system comprising: an image capture device and a content decoder for decoding content encoded in a sequence of display frames, each display frame comprising an encoded image, the encoded image comprising a source image modulated by a two dimensional pattern of luminosity modulations to encode the content within the source image, the content decoder comprising: inputs for receiving the sequence of display frames; a processor arranged to (i) process the sequence of display frames to determine the two dimensional pattern of luminosity modulations; (ii) to sample the two dimensional pattern of luminosity modulations to determine the encoded content within each display frame, and (iii) to decode the encoded content to determine the content; outputs to output the content wherein the inputs of the content decoder are in communication with the image capture device.

The invention also extends to a mobile communications device (such as a mobile phone) that comprises such an image capture system.

The invention may also be expressed as a carrier medium comprising a computer program to implement the methods according to the third and fourth embodiments of the invention.

Therefore, according to a further embodiment the present invention there is provided a carrier medium for controlling a computer, processor or mobile telecommunications device to encode content in a source image for display on a display device, the carrier medium carrying computer readable code comprising: a code segment for receiving data representing content to be encoded in the source image; a code segment for encoding the content into the source image to form an encoded image, content being encoded as a time varying two-dimensional pattern of luminosity modulations within the source image; and a code segment for outputting the encoded image to the display device.

According to a yet further embodiment of the present invention there is provided a carrier medium for controlling a computer, processor or camera-equipped mobile telecommunications device to decode content encoded in a sequence of display frames, each display frame comprising an encoded image, the encoded image comprising a source image modulated by a two dimensional pattern of luminosity modulations to encode the content within the source image, the carrier medium carrying computer readable code comprising: a code segment for receiving the sequence of display frames; a code segment for processing the sequence of display frames to determine the two dimensional pattern of luminosity modulations; a code segment for sampling the two dimensional pattern of luminosity modulations to determine the encoded content within each display frame; a code segment for decoding the encoded content to determine the content; and a code segment for outputting the content.

### BRIEF DESCRIPTION OF THE DRAWINGS

In order that the invention may be more readily understood, reference will now be made, by way of example, to the accompanying drawings in which:

FIG. 1 shows image display and image capture devices in accordance with an embodiment of the present invention;

FIGS. 2a to 2g are representations of steps in the encoding process in accordance with an embodiment of the present invention;

FIGS. 3a and 3b illustrate the luminosity modulation applied to a region of an image in accordance with an embodiment of the present invention;

FIGS. 4a to 4c show two alternatives for adding entropy to the encoding process in accordance with embodiments of the present invention;

FIG. 5 is a flow chart of a content encoding process in accordance with an embodiment of the present invention;

FIG. 6 is a flow chart showing part of the process depicted in FIG. 5 in greater detail;

FIG. 7 is a flow chart depicting the decoding process in accordance with an embodiment of the present invention;

FIGS. 8a to 8c show various luminosity modulation schemes in accordance with embodiments of the present invention.

### DETAILED DESCRIPTION

In the following description, the term “display frame” is taken to be any frame in a series of video frames or sequence of images that are displayed on a display device or any image frame that is displayed on a screen for capture by a code reader device.

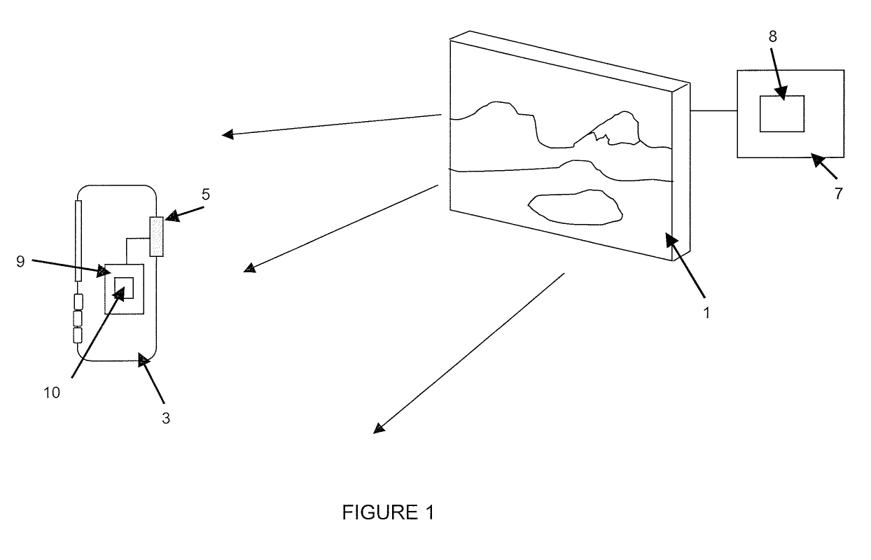

FIG. 1 shows an image display device 1 and an image capture device 3 in accordance with an embodiment of the present invention.

The image display device 1 may, for example, be a computer or television screen, a digital poster display or any other type of video display screen.

The image capture device 3 depicted in the present embodiment is a mobile telecommunications device comprising a camera 5. However, any image capture device capable of receiving and recording a visual image may be used.

The image display device 1 is controlled by a content encoder 7, for example a dedicated PC, which comprises a processor 8. The content encoder 7 is arranged, via its processor 8, to encode content within an arbitrary image displayed by the image display device 1.

The image capture device 3 comprises a content decoder 9 for receiving and decoding content sent from the image display device 1. The image capture device 3 comprises a processor 10 for analysing and processing images captured by the camera 5.

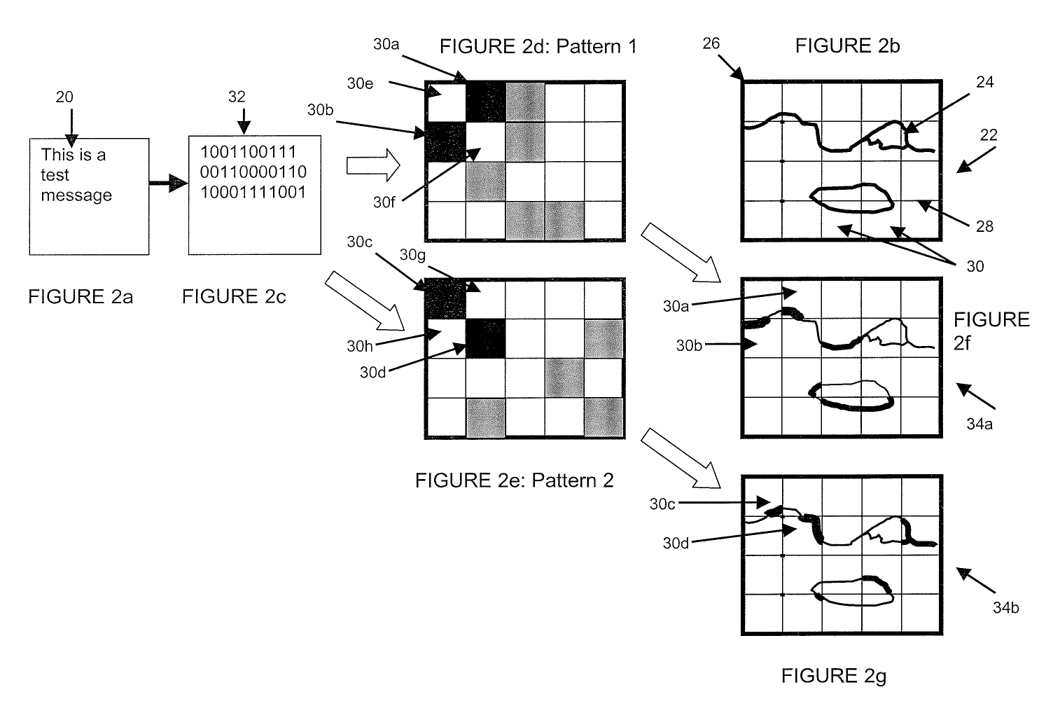

FIGS. 2a to 2g are representations of steps in the encoding process in accordance with an embodiment of the present invention.

The content encoder 7 is arranged via the processor 8 to encode, for example, text based content 20 (FIG. 2a) into an arbitrary image (as shown in FIG. 2b).

FIG. 2b represents a single display frame 22 in a finite sequence of video frames that are to be displayed in a continuous cycle. Frame 22 comprises an arbitrary image 24 that is framed by a solid colour border 26 or quiet zone that strongly contrasts with the visual content of the image 24. The image 24 is divided into a grid 28 of cell regions 30, the dimensions of which will be constant over all frames in the sequence. It is noted that there will be a plurality of image pixels in each cell 30 of the grid 28.

The content encoder 7 is arranged via the processor 8 to encode the content 20 into the image 24 as a changing pattern of brightness fluctuations (luminosity modulations) across the grid 28. In use, the content encoder 7 receives the content 20 to be encoded into the image 24 and, as shown in FIG. 2c, this content is converted by the processor 8 into a sequence of data bits 32, e.g. a binary bit sequence, which is then applied across successive frames in the finite sequence of display frames to be displayed by the display device 1.

Each cell 30 within the grid 28 is, in an embodiment of the invention, capable of encoding one raw bit of data (e.g. “1” or “0”). To encode a “1” the brightness of pixels in a cell may, for example, be raised by the addition of a constant luminosity component to the image 24. To encode a “0”, the brightness of pixels may be lowered by a corresponding amount.

FIGS. 2d and 2e show two brightness fluctuation patterns (pattern 1 and pattern 2) that are to be applied/encoded to two successive display frames in the sequence of display frames to be sent to the image display device 1. The brightness patterns 1 and 2 represent part of the sequence of data bits 32. A positive luminosity component is indicated in the Figure by a shaded grid cell 30. A negative luminosity component is indicated by a blank grid cell 30.

It is noted that the brightness fluctuation patterns 1 and 2 are different.

FIG. 2f shows a modulated image 34a. Modulated image 34a comprises the image 24 after pattern 1 has been encoded to it. It can be seen that regions of the image 34a that correspond to shaded cells 30 in pattern 1 have a higher luminosity than the original image 24 (as indicated by the trace lines in FIG. 2f that are thicker than the corresponding trace lines in FIG. 2b). Regions of the image 24 that correspond to the blank cells 30 in pattern 1 have a lower luminosity than in the original image 24 (as indicated by the trace lines in FIG. 2f that are thinner than the corresponding trace lines in FIG. 2b).

FIG. 2g shows a further modulated image 34b. Modulated image 34b comprises the image 24 after pattern 2 has been encoded to it. It can be seen that the luminosity of the image 34b has altered from FIG. 2f.

FIGS. 2f and 2g represent two images (34a, 34b) that are displayed on the image display device 1 as part of the finite series of display frames that encode the content 20.

Luminosity in the arbitrary image 24 may be globally scaled by the processor 7 prior to the encoding process in order to reduce the risk of excessively high or low luminosity values.

In order for the transmitted image (34a, 34b) to be decoded successfully by the image capture device 1 and content decoder 9, the processor 8 of the content encoder 7 may also insert an orientation flag into the modulated image. This flag enables the modulated images 34 to be read at any angle or orientation.

The orientation flag may be realised by boosting the level by which luminosity is modulated in a particular region of the grid 28 compared to the luminosity fluctuations shown in FIGS. 2d and 2e.

In the present embodiment of the present invention, the luminosity in the top-left quadrant of the image 24 has been further modulated compared to the brightness fluctuations that are applied to the remainder of the grid area.

For example, in FIG. 2d, cells 30a and 30b indicate a positive luminosity modulation component. However, in order to provide the orientation flag, the magnitude of the component in these cells is actually higher than the other cells which represent a positive luminosity modulation component (this is indicated in FIG. 2d by heavier shading in cells 30a and 30b compared to the shading in other parts of the grid). Cells 30c and 30d in FIG. 2e are similarly modulated and represented.

Although not depicted for the sake of clarity in FIGS. 2d and 2e, cells that represent a negative luminosity modulation component are similarly modulated in this top left quadrant. For example, the luminosity component at cells 30e, 30f, 30g and 30h will be less that the component at other blank cells 30 such that the luminosity in the image 24 will be lowered by a smaller amount in the top left quadrant than in the remainder of the image.

The above described modulation of cells 30a to 30d is also represented in FIGS. 2f and 2g in which the trace lines in cells corresponding to cells 30a and 30b in FIG. 2d and cells 30c and 30d in FIG. 2e are thicker than the raised luminosity trace lines in the rest of the image 24.

It is noted that the brightness discontinuities produced by the encoding of content are accentuated by the human visual system by an effect called the “Mach banding effect”. In order to counteract this effect the luminosity modulations may be arranged such that they decay towards the edge of each grid cell. This decay may conveniently be attenuated logarithmically towards the edges of the cell.

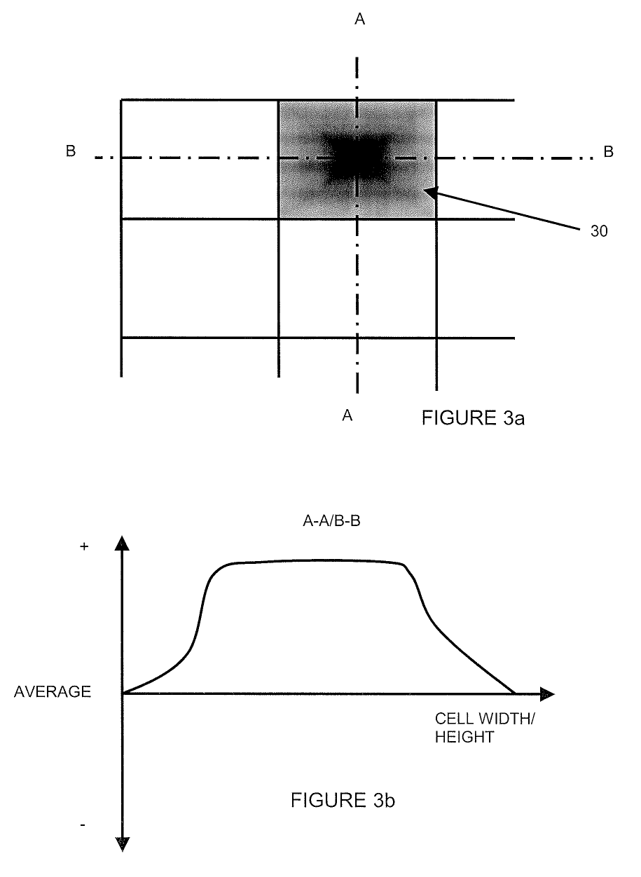

FIGS. 3a and 3b show an example of a cell where the luminosity modulation is attenuated towards the edges of the cell. FIG. 3a shows a particular cell 30 in which the luminosity component reduces towards the edge of the cell. FIG. 3b shows the luminosity variation across the cell 30 of FIG. 3a along lines A-A and B-B.

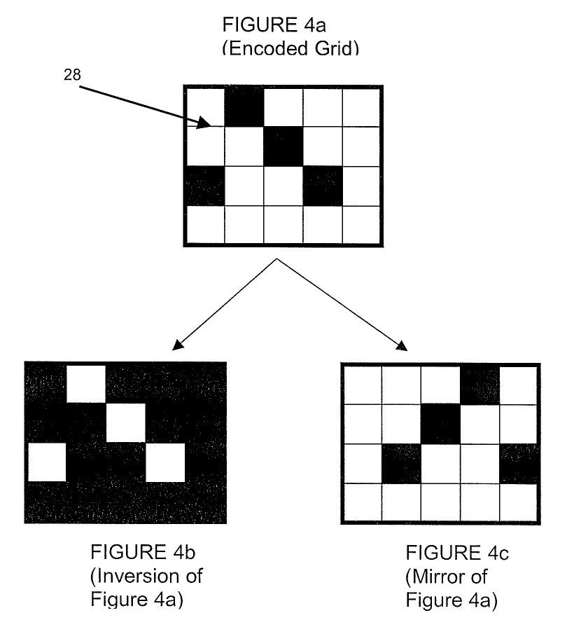

As discussed below, in one embodiment of the decoding process it is necessary for the content decoder 9 (i.e. the processor 10 within the decoder 9) to observe cells 30 in both their “1” and “0” states in order to reconstruct the arbitrary image 24. In order to increase the likelihood that each cell will be observed in both of these states, the processor 8 of the content encoder 7 may arrange for simple entropy to be added to the system by either inverting the bit pattern to be encoded to the grid 28 or by inverting the grid pattern—see FIGS. 4a to 4c.

FIG. 4a represents an encoded grid 28. In order to add entropy to the system the bit pattern may be inverted (FIG. 4b shows the grid pattern that would result from an inverted bit pattern) or the grid pattern itself may be switch from left to right (see FIG. 4c in which the position of cells 30 has been switched relative to an axis running vertically through the middle of the grid 28).

An example of the use of the content encoding process would be in an advertising poster. A poster comprising a display screen may, for example, depict a car for sale. The content encoder 7 may be used to encode additional information about the vehicle (sale price, specifications, special offers etc) into the video image of the advert. The changing pattern of brightness fluctuations would make the image of the car in the advert “twinkle” as cells 30 in the grid 28 moved between different luminosity levels.

The ratio of pixels per grid cell 30 and the amplitude of luminosity modulations when encoding each cell are user configurable. Aesthetics may be traded for robustness by reducing the amplitude of the changes in the luminosity thereby causing the “twinkling” in the modulated image to become more subtle. This may improve the aesthetics of the modulated image (by reducing its obviousness to observers) but will result in greater noise in the bit channel as cells can become misclassified during the decoding process.

Increasing the degree of cell smoothing to counter the “Mach banding effect” can also improve aesthetics but introduces additional noise that can reduce the efficiency of the decoder 9.

Spatial and temporal density of the code may be increased in order to store more raw data thereby creating a trade off between capacity and decoding robustness (e.g. camera sampling limitations may cause frames to be dropped or cells to become unresolvable).

As noted above, the encoding process in accordance with an embodiment of the present invention may be used to encode content within an arbitrary image. Grid sequences of 20 or so frames would be capable of encoding around 10 KB of data. For frame rates of around 10 frames per second (which equates to a typical mobile telecommunications device camera frame rate) this would mean that a user would be required to capture the modulated image for around 2 seconds in order to receive the complete sequence of display frames embodying the content 20.

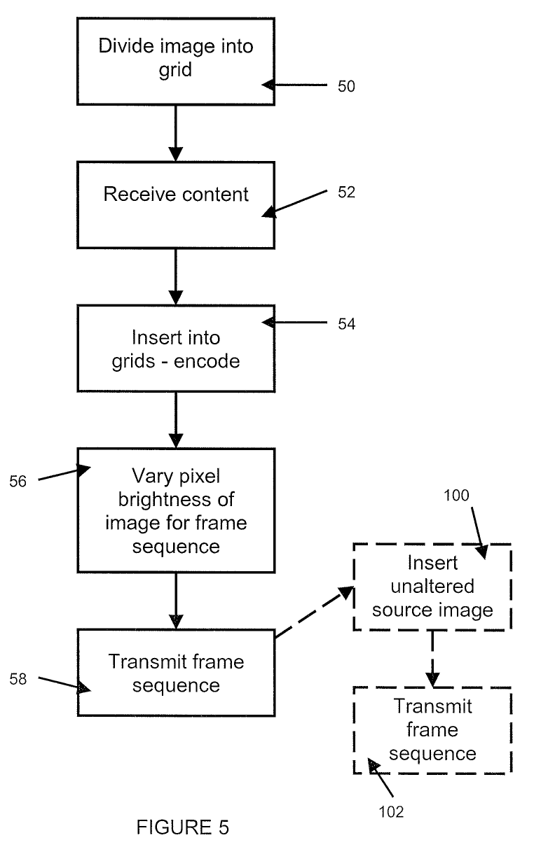

FIG. 5 is a flow chart showing an overview of the encoding process in accordance with an embodiment of the present invention.

In Step 50, the processor 8 of the encoder 7 divides the arbitrary image 24 to be encoded into a grid of cell regions.

In Step 52, content 20 to be sent via the image display device 1 to the image capture device 3 is received by the content encoder 7. The content may, for example, be a text message to be sent.

The received content 20 is converted into a bit stream and is encoded into a sequence of grids 28 in Step 54. Each grid 28 represents a brightness fluctuation pattern.

In Step 56 the brightness fluctuation patterns contained within the sequence of grids 28 from Step 54 are applied to the arbitrary image 24 to form a sequence of modulated display frames (34a, 34b). This step involves varying the brightness of pixels within the cell regions in order to encode the brightness fluctuations from Step 54 into the image 24.

In Step 58 the content encoder 7 sends the sequence of modulated image frames to the image display device 1.

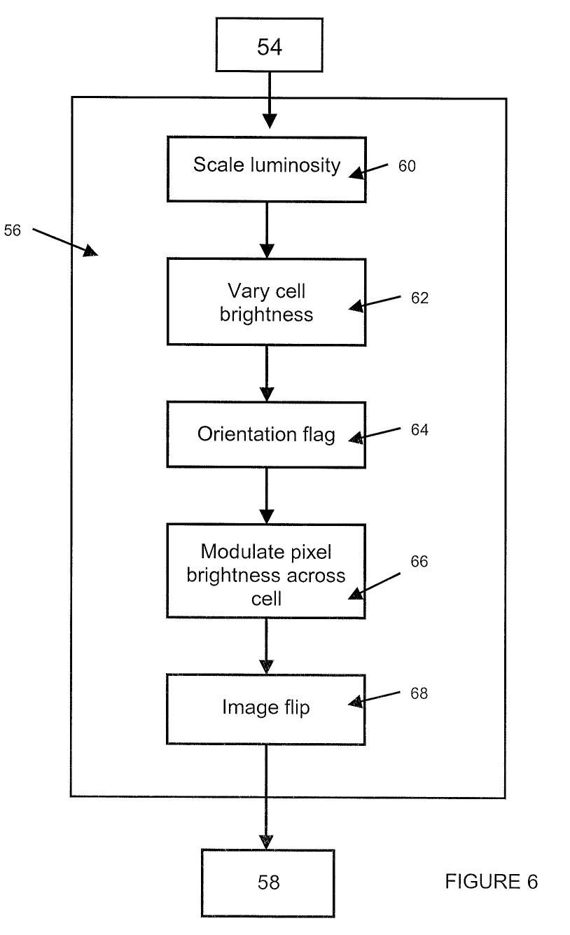

FIG. 6 is a further flow chart showing Step 56 from FIG. 5 in greater detail.

Prior to modulating the cells of the image 24, the processor 8 of the encoder 7, in Step 60, first scales the luminosity of the image 24 in dependence on the positive and negative luminosity components in the sequence of grids 28 generated in Step 54. This ensures that the modulated image 34 does not comprise any excessively high or low luminosity values.

In Step 62 the pixels of the image 24 are varied in line with the luminosity components in the grids 28 from Step 54.

In Step 64, the orientation flag discussed with reference to FIG. 2 is applied to the modulated image. In one embodiment this orientation flag comprises raising the luminosity levels of all pixels in one quadrant, e.g. the top left quadrant, of the image. This is done so that an image decoder 9 can determine the correct orientation of the modulated image frames 34a, 34b prior to decoding.

In Step 66, the brightness of pixels within individual cells 30 can be varied in order to counteract the Mach banding effect.

In Step 68, successive modulated images may be inverted (either by rotation of the modulated image or by inversion of the values in the bit stream) in order to introduce entropy into the modulated image frames.

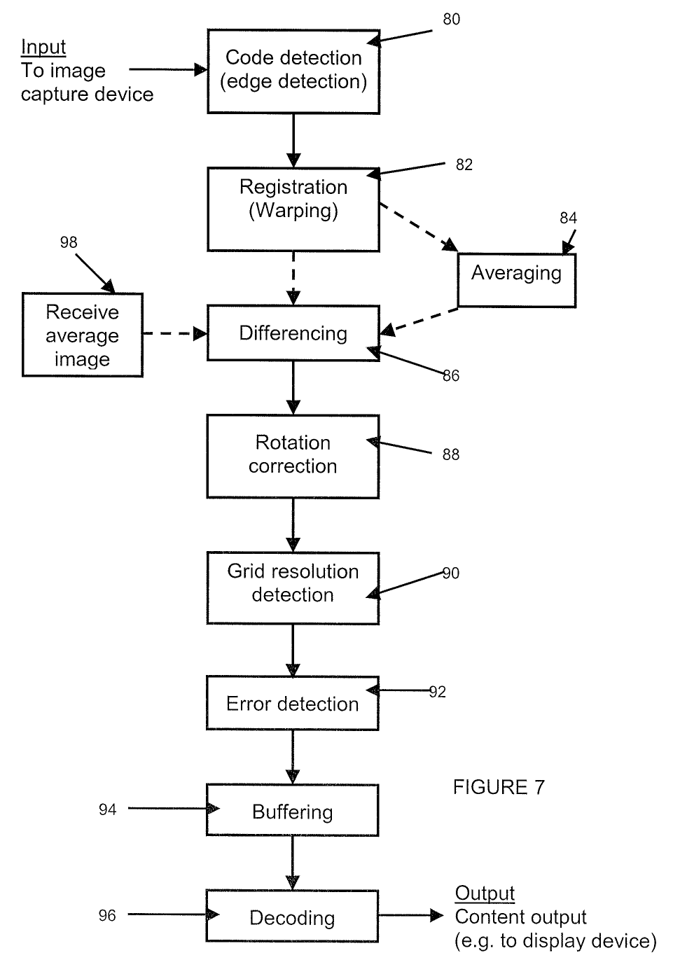

FIG. 7 shows a flow chart of a decoding process in accordance with an embodiment of the present invention. In use, a user points their image capture device 3 at a video display 1 that has been encoded with content in accordance with the encoding process of an embodiment of the present invention. Any content that is located in the video stream (sequence of display frames displayed on the display device) is then decoded in accordance with the following steps.

In Step 80, the processor 10 of the content decoder 9 locates regions of the captured display frames that may contain encoded content. As noted above, the modulated image is bounded by a continuous strong edge 26. To locate regions containing encoded content, the following image processing steps are performed:—
a) Firstly, strong edge contours are detected within in the display frame using standard image processing techniques. This step identifies any edges within the received the trace lines in cells 30a and 30b being thicker than the trace lines in the other shaded cells frames;
b) Secondly, connected edge contours are traced to find approximately straight segments and long segments are flagged as candidate edges that may bound encoded content.
c) Thirdly, straight edges in close proximity and approximately 90 (+/−30) degrees from each other, are connected together to create candidate corner features.
d) Finally, permutations of candidate corner features are examined to identify the most likely location of the encoded content region within the display frame. The orientation and proximity of candidate corners are used to reduce the number of permutations in the search, enabling real-time processing speeds.

In Step 82, each received display frame undergoes a registration step in which the encoded content region is cropped from the display frame and warped to a rectilinear basis of fixed size. This registers the encoded content region to a standard position, regardless of the viewing angle, position or scale of the region in the display frame. If necessary, the image may be converted to a greyscale (intensity) image in this step. The “registered” display frames from Step 82 are then passed to Step 84.

In Step 84 (according to a first embodiment of the decoding process) the first few registered display frames (approximately the first 10 frames) received during the decoding process are analysed to create an “average” image. This averaging step comprises recording the maximum and minimum values of each pixel over time and using their mean values to reconstruct a version of the basic image (image 24) that exhibits no brightness fluctuations. The first few registered frames used to create this average are stored in a buffer and, once the “average” image has been computed, submitted for processing to Step 86. Once these buffered frames have been processed, subsequent video frames pass directly to Step 86 and do not affect the “average” image. The buffering of frames in this way ensures that no data is lost while creating the “average” image, so reducing the overall decoding time.

Step 86 is a “differencing” step in which received registered frames are subtracted from the “average” image to produce a “difference” image. Negative values are present in the image where brightness was less than average; positive values where brightness was greater than average.

Step 88 corrects for the rotation of the received image. Due to orientation of the mobile camera, or the permutation based search of Step 80(d), the registered image frame may be rotated by either 0, 90, 180 or 270 degrees. The difference image from Step 86 is divided into four quadrants, within which absolute values are compared to locate the quadrant exhibiting the greatest brightness fluctuation amplitude. As discussed earlier, the greatest amplitude should be found in the top-left quadrant of the display frame. The differenced display frame is rotated by 90 degrees the required number of times to ensure that this is so.

In Step 90 the resolution of the grid embedded within the display frame is determined. A Fourier analysis is performed on the rotated difference image from Step 86 to determine the resolution of the grid embedded within the image. At Step 86 all source image data has been subtracted from the received image, and high frequencies are due to the remaining grid pattern.

In Step 92 the grid is sampled for content data. With the resolution of the grid detected, and the display frame content registered and correctly oriented, it is possible to iterate over the difference image and measure the value (positive=1, negative=0) of each cell. The binary signal sampled from the grid is compared to the signals decoded in any previous display frames. If the signal is very similar or identical to that obtained from the previous frame, then the current frame is discarded as a duplicate (i.e. the camera 5 has resampled the display 1 before the next frame of the sequence was displayed).

In Step 94 channel based error detection is performed. Various error conditions can arise due to the nature of the transmission channel between the image display device 1 and the image capture device 5; frames may become corrupt, or be wholly or partially lost due to timing errors.

By analogy with the OSI (Open Systems Interconnection) layered model for network protocols, the transmission of content can be thought of as representing a “physical layer” over a “light wire” from display device to capture device. Typically, error detection would be applied by higher layers. For a sequence of frames that continuously cycles it may also be necessary to determine the sequence of the frames, e.g. the start and end frames etc. Such “synchronization” detection may also be performed in Step 94 although it is noted that typically synchronization would also be applied by higher layers.

In Step 94, as the binary grid within each display frame is decoded, the grid of bits are stored in a buffer that persists over time. When a grid pattern is received that is (a) close to identical to a previously received pattern, and (b) was not rejected as a sampling problem in Step 92, then the processor 10 of the image decoder 9 determines that a full sequence of display frames has been received (i.e. the finite sequence of video frames that are to be displayed in a continuous cycle has begun a new iteration). In Step 96, assuming no errors are present at this stage, the raw data bits are decoded. As noted above, to promote even distribution of light (1) and dark (0) fluctuations in the image (which improves the “average” image reconstruction), the raw data bits in each second frame were inverted on encoding. These bits must now be inverted for correct decoding. Various techniques may be used to detect the frames requiring inversion, through the dedication of bits for this purpose. Finally, the raw data bits are passed to a decoding algorithm within the processor 10 of the content decoder 9 and the original content 20 is recovered.

In the embodiment described above in relation to FIG. 7, an averaging step (Step 84) was performed in order to ascertain the basic source image, i.e. the image without any brightness modulations.

In an alternative embodiment of the invention, the image display device 1 and content encoder 7 may be configured to transmit an unaltered version of the source image. This would enable the content decoder 9 to bypass Step 84 and progress from Step 82 to Step 86 in the above decoding process. The reception of an unaltered image is depicted in Step 98 in FIG. 7 and this alternative embodiment is designated by the dotted lines.

In order to allow the content decoder 9 to distinguish an unaltered version of the source image 24 from the modulated images (34a, 34b), the content encoder will need to signal the transmission of an unmodulated image. This may be achieved in a number of ways. For example, the image may be notified via a separate communications channel (e.g. IR signal, Bluetooth signal) or alternatively the transmitted image may comprise out-of-band identifiers (e.g. there may be pixels in the display 1 that are not being used for display of the image 24 but which may be used to notify the transmission of an unaltered image).

In one particular embodiment of the present invention, the frame area 26 of the display device 1 may be used to signal the transmission of an unaltered image 24. This may be achieved by, for example, a change in colour of the frame 26.

The flow chart of FIG. 5 also depicts the above-described alternative embodiment where an unaltered image is transmitted. This embodiment is designated by the dotted regions of the Figure. In Step 100, an unaltered image 24 is inserted into the sequence of display frames. In Step 102, the modified sequence of display frames is transmitted with the content encoder 7 additionally sending an identifier signal whenever an unaltered image is displayed.

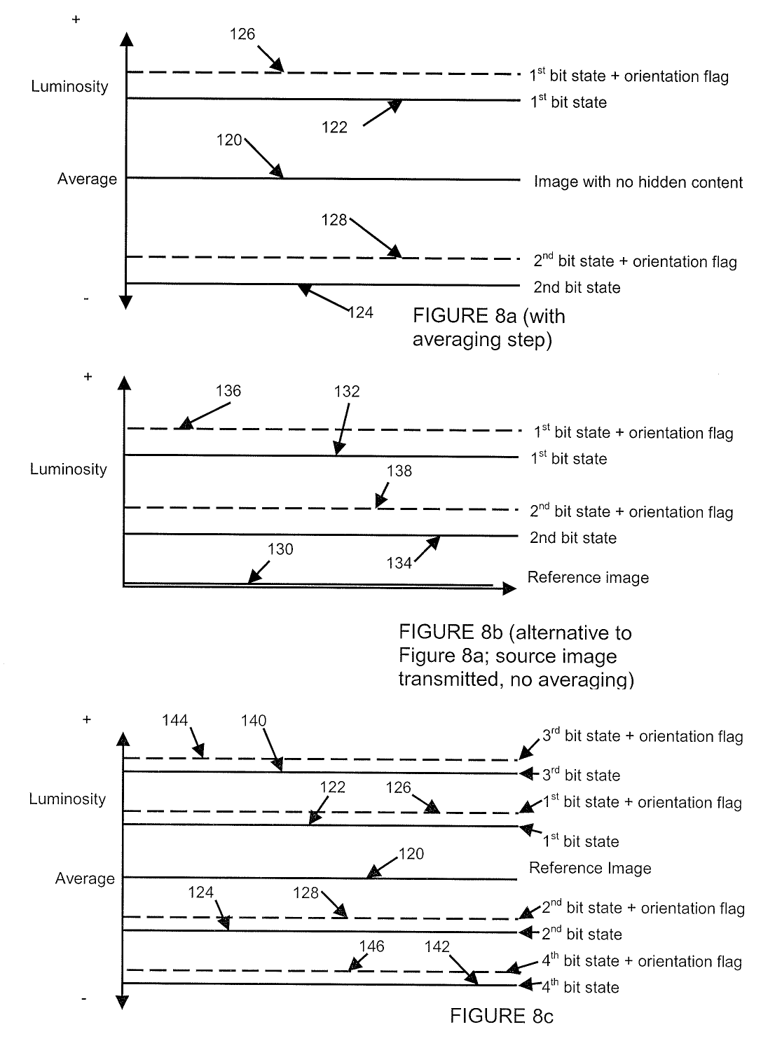

FIGS. 8a to 8c depict various modulation schemes in accordance with various embodiments of the present invention.

FIG. 8a relates to the embodiment described above in relation to FIGS. 2 to 7 in which 1 bit of data is encoded into each grid cell 30 and the decoding process incorporates an averaging step (Step 84).

In the embodiment of FIG. 8a, content is encoded either as an increase or decrease in the brightness of cells 30. The average brightness of a particular cell is shown by line 120. Lines 122 and 124 show the increased and decreased brightness levels respectively for the cell in question—line 122 may for example relate to the first bit state “1” and line 124 may relate to the second bit state “0”.

As described above, each display frame may also include an orientation flag to enable the content decoder 9 to determine the correct orientation of the received display frames. The variations to the brightness levels 122, 124 that the orientation flag introduces is shown by lines 126 and 128.

FIG. 8b relates to a further embodiment of the present invention that may be used in conjunction with the embodiment of the invention where an unaltered version of the source image is displayed. In the embodiment of FIG. 8b, content is encoded as either an increase of cell brightness from the unaltered (reference) level 130 to a first level 132 or as an increase of cell brightness from the unaltered (reference) level 130 to a second level 134. This further embodiment may also include an orientation flag to enable the content decoder 9 to determine the correct orientation of the received image frames and the variations to the brightness levels 132, 134 that the orientation flag introduces is shown by lines 136, 138 respectively.

FIG. 8c relates to a yet further embodiment of the present invention in which 2 bits of data are encoded into each grid cell 30 and the decoding process incorporates an averaging step (Step 84).

In the embodiment of FIG. 8c there are two further brightness levels 140, 142 in addition to those (122, 124) shown in FIG. 8a. [It is noted that like numerals have been used in FIG. 8c to denote like features with FIG. 8a].

Brightness level 140 represents an increased brightness level relative to the average brightness level 120 that is above level 122. Brightness level 142 represents a decreased brightness level relative to the average brightness level 120 that is below level 124.

Modification to the four brightness levels (122, 124, 140, 142) as a result of an orientation flag is also shown in FIG. 8c at levels (126, 128, 144, 146).

It will be understood that the embodiments described above are given by way of example only and are not intended to limit the invention, the scope of which is defined in the appended claims. It will also be understood that the embodiments described may be used individually or in combination.

It is noted that although grids of dimensions 5 cells by 4 cells have been depicted in the above examples any grid size (e.g. 30×20) may be used.

1. A content encoder for encoding content in a source image for display on a display device, the content encoder comprising:
inputs for receiving data representing content to be encoded in the source image;
a processor arranged to encode content as a time varying two-dimensional pattern of luminosity modulations within the source image to form an encoded image;
outputs arranged to output the encoded image to the display device.

2. A content encoder as claimed in claim 1, wherein the processor is arranged to encode content into a sequence of display frames for display on the display device such that each image frame comprises an encoded image, and the outputs are arranged to output the sequence of image frames to the display device.

3. A content encoder as claimed in claim 2, wherein each display frame in the sequence of display frames encoded by the processor comprises a source image, the luminosity of which is modulated in a two dimensional pattern in dependence on the content received by the inputs.

4. A content encoder as claimed in claim 2, wherein the two dimensional pattern of luminosity modulations encoded by the processor into the source image varies between image frames.

5. A content encoder as claimed in claim 1, wherein the two dimensional pattern is a grid of cells and content is encoded into the source image by raising or lowering the luminosity of pixels within a given cell of the grid.

6. A content encoder as claimed in claim 5, wherein each cell in the grid is arranged to encode one bit of content related data.

7. A content encoder as claimed in claim 1, wherein the processor is arranged to scale the luminosity of the source image prior to encoding content into the source image.

8. A content encoder as claimed claim 1, wherein the processor is arranged to modulate the luminosity of the image by a first amount in order to encode content into the source image and wherein processor is arranged to modulate the luminosity of the image by a further amount in order to insert an orientation flag into the encoded image.

9. A content encoder as claimed in claim 8, wherein the processor is arranged to insert the orientation flag within a predefined portion of the encoded image.

10. A content encoder as claimed in claim 1, wherein the two dimensional pattern is a grid of cells and the processor is arranged to attenuate the luminosity modulation applied to any given cell towards the edges of the cell.

11. A content encoder as claimed in claim 1, wherein the processor is arranged to encode content into a sequence of display frames for display on the display device such that each image frame comprises an encoded image, and the outputs are arranged to output the sequence of image frames to the display device and the processor is arranged to invert the content encoded to a subset of the display frames within the sequence of display frames.

12. A content decoder for decoding content encoded in a sequence of display frames, each display frame comprising an encoded image, the encoded image comprising a source image modulated by a two dimensional pattern of luminosity modulations to encode the content within the source image, the content decoder comprising:
inputs for receiving the sequence of display frames;
a processor arranged to (i) process the sequence of display frames to determine the two dimensional pattern of luminosity modulations; (ii) to sample the two dimensional pattern of luminosity modulations to determine the encoded content within each display frame, and (iii) to decode the encoded content to determine the content;
outputs to output the content.

13. A content decoder as claimed in claim 12, wherein the processor is arranged to analyse a number of display frames in the received sequence of display frames and to determine a mean value for the luminosity of each pixel in the display frame in order to determine the source image.

14. A content decoder as claimed in claim 12, wherein the inputs are arranged to receive an unmodulated version of the source image.

15. A content decoder as claimed in claim 12, wherein the processor is arranged to analyse the sequence of display frames in order to locate the pattern of luminosity modulations within the display frame and the processor is arranged to warp the pattern to a fixed two dimensional shape.

16. A content decoder as claimed in claim 12, wherein the processor is arranged to analyse the sequence of display frames in order to locate the pattern of luminosity modulations within the display frame and the two dimensional pattern of luminosity modulations is arranged to extend over a portion of the display frame and the processor is arranged to crop the pattern from the display frame.

17. A content decoder as claimed in claim 12, wherein the processor is arranged to rotate each display frame in the sequence of display frames received by the inputs to a predetermined orientation.

18. A content decoder as claimed in claim 12, wherein the pattern of luminosity modulations is in the form of a grid of cells and the processor is arranged to determine the resolution of the grid in the sequence of display frames.

19. A content decoder as claimed in claim 18, wherein the processor is arranged to analyse each grid cell in order to determine content encoded within the grid and the processor is arranged to analyse the content decoded from a current display frame and to compare it to content decoded from the previous display frame in the sequence, the current display frame being discarded if it is substantially similar to the previous display frame.

20. A method of encoding content in a source image for display on a display device, the method comprising the steps:
receiving data representing content to be encoded in the source image;
encoding the content into the source image to form an encoded image, content being encoded as a time varying two-dimensional pattern of luminosity modulations within the source image;
outputting the encoded image to the display device.
